(19) United States
(12) Patent Application Publication
(10) Pub. No.: US 2010/0165202 A1
(43) Pub. Date: Jul. 1, 2010

(54) TELEVISION RECEIVER AND TELEVISION RECEIVING METHOD

(75) Inventor: Makoto Sato, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/499,662

(22) Filed: Jul. 8, 2009

(30) Foreign Application Priority Data
Dec. 25, 2008 (JP) 2008-331309

(51) Int. Cl. H04N 5/50

(52) U.S. Cl. 348/570; 348/731; 348/E05.097

(57) ABSTRACT

According to one embodiment, a television receiver includes a receiver, a setting module, a timer, and an indicator. The receiver selectively receives a plurality of broadcasts in response to the switching of channels. The setting module sets a channel as a viewed channel when a predetermined time has elapsed since switching to the channel. The timer counts the elapsed time until a new viewed channel is set through at least one channel switching from the viewed channel. The indicator indicates the elapsed time while a channel other than the viewed channel is selected.

### CROSS-REFERENCE TO RELATED APPLICATIONS

This application is based upon and claims the benefit of priority from Japanese Patent Application No. 2008-331309, filed Dec. 25, 2008, the entire contents of which are incorporated herein by reference.

### BACKGROUND

1. Field

One embodiment of the invention relates to a television receiver that receives television broadcast and a television receiving method.

2. Description of the Related Art

In recent years, as the digital broadcasting service provides multiple channels, the number of channels has been increasing. Accordingly, viewers often go channel surfing or zapping to frequently switch channels while watching television. In view of this, there have been proposed various technologies related to the switching of channels. For example, Japanese Patent Application Publication (KOKAI) No. 2005-109567 discloses a conventional technology, in which a period of time that has elapsed since channel switching is displayed on the screen to encourage the viewer to revert back to the original channel.

Although the viewer can switch a plurality of channels by zapping, a channel (hereinafter, “viewed channel”) that the viewer frequently views is determined. Therefore, there is a need for a technology that allows the viewer to easily revert back to a viewed channel after zapping. With the conventional technology described above, the period of time displayed on the screen indicates only a time period elapsed between the display of two screens, i.e., a screen (broadcast screen) immediately before the channel switching and a screen (browser screen, etc. over the Internet, etc.) immediately after the channel switching. It means that, if a viewed channel has been switched to a plurality of channels, a period of time that has elapsed since switching from the viewed channel cannot be displayed. As a result, there is no support for the viewer to revert back to the viewed channel.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic block diagram of a television (TV) receiver according to a first embodiment of the invention;

FIG. 2 is an exemplary schematic diagram for explaining how to indicate selection support information in the first embodiment;

FIG. 3 is an exemplary state transition diagram for explaining two states determined by a channel selection support module illustrated in FIG. 1 and the path of each process performed in each of the states in the first embodiment;

FIG. 4 is an exemplary timing chart for explaining the operation of the channel selection support module in the first embodiment;

FIG. 5 is an exemplary schematic block diagram of a TV receiver according to a second embodiment of the invention; and

FIG. 6 is an exemplary schematic diagram for explaining how to indicate an elapsed time period in the second embodiment.

### DETAILED DESCRIPTION

Various embodiments according to the invention will be described hereinafter with reference to the accompanying drawings. In general, according to one embodiment of the invention, a television receiver comprises a receiver, a setting module, a timer, and an indicator. The receiver is configured to selectively receive a plurality of broadcasts in response to the switching of channels. The setting module is configured to set a channel as a viewed channel when a predetermined time has elapsed since switching to the channel. The timer is configured to count the elapsed time until a new viewed channel is set through at least one channel switching from the viewed channel. The indicator is configured to indicate the elapsed time while a channel other than the viewed channel is selected.

According to another embodiment of the invention, there is provided a television receiving method comprising: selectively receiving a plurality of broadcasts in response to the switching of channels; setting a channel as a viewed channel when a predetermined time has elapsed since switching to the channel; counting the elapsed time until a new viewed channel is set through at least one channel switching from the viewed channel; and indicating the elapsed time while a channel other than the viewed channel is selected.

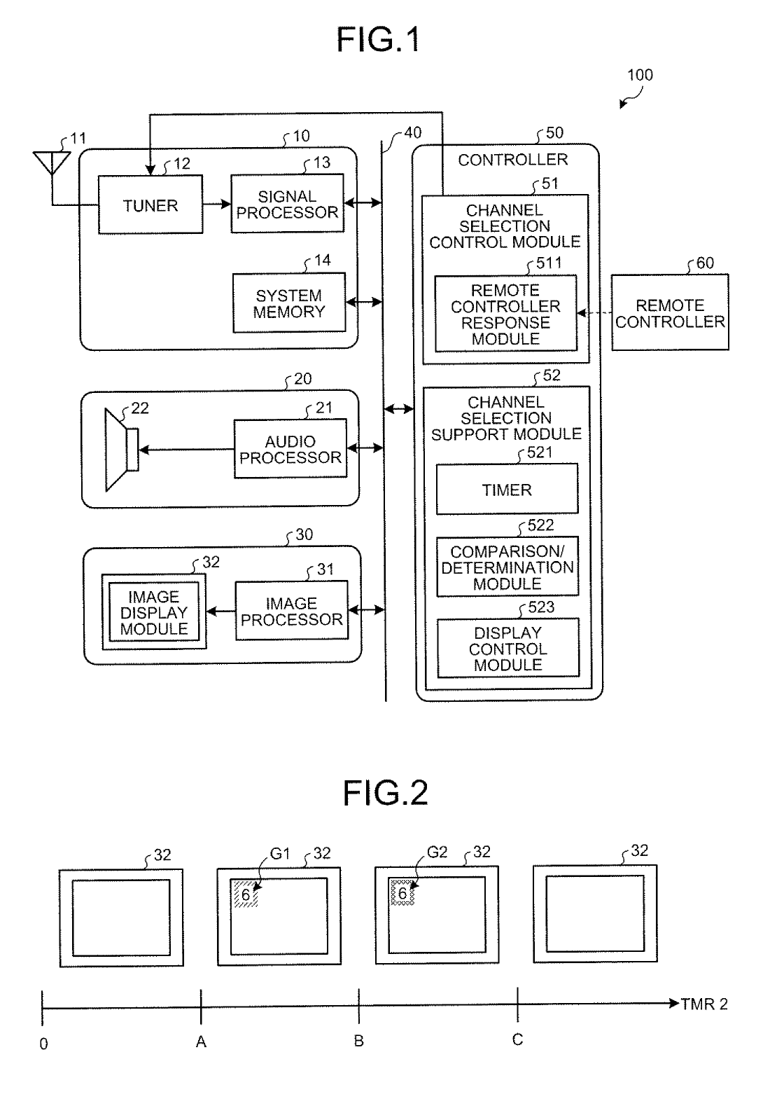

FIG. 1 is a schematic block diagram of a television (TV) receiver 100 according to a first embodiment of the invention. As illustrated in FIG. 1, the TV receiver 100 comprises a TV signal receiving module 10, an audio output module 20, a video output module 30, a bus 40, a controller 50, and a remote controller 60.

The TV signal receiving module 10 comprises an antenna 11, a tuner 12, a signal processor 13, and a system memory 14. The antenna 11 receives analog broadcasting and digital broadcasting such as digital terrestrial broadcasting as a TV signal. The tuner 12 is used to select a broadcast station (a channel) under the control of a channel selection control module 51, which will be described later. The signal processor 13 demodulates the TV signal and outputs it to the system memory 14 as a digital video signal. The system memory 14 temporarily stores the video signal received from the signal processor 13 through the bus 40. The “video signal” as used herein includes audio signals as well as image signals such as still image signals and moving image signals.

The audio output module 20 comprises an audio processor 21 and a speaker 22. The audio processor 21 converts a digital audio signal stored in the system memory 14 to an analog audio signal in a format reproducible by the speaker 22, and output the audio signal to the speaker 22. The speaker 22 outputs the audio signal received from the audio processor 21.

The video output module 30 comprises an image processor 31 and an image display module 32. The image processor 31 may be, for example, a display driver. The image processor 31 controls the display of the video signal stored in the system memory 14, and also controls the display of a channel selection support image under the control of a display control module 523, which will be described later. The image display module 32 is a display device such as a liquid crystal display (LCD) panel, a plasma panel, or a surface-conduction electron-emitter display (SED) panel. Under the control of the image processor 31, the image display module 32 displays an image corresponding to the image signal.

The TV signal receiving module 10, the audio output module 20, and the video output module 30 are connected via the bus 40 to the controller 50, and operate under the control of the controller 50.

The controller 50 is configured of a microprocessor, a read only memory (ROM), a random access memory (RAM), and the like, and controls the overall operation of the TV receiver 100. The controller 50 comprises the channel selection control module 51 and a channel selection support module 52 as functional modules related to channel switching.

The channel selection control module 51 comprises a remote controller response module 511 that is capable of receiving a command signal sent from the remote controller 60. When receiving through the remote controller response module 511 a channel selection signal specifying a specific channel, the channel selection control module 51 controls the tuner 12 to select the channel.

With this, a video signal from the channel selected by the viewer is output from the audio output module 20 and the video output module 30. Incidentally, a channel selection signal that has been received through the remote controller response module 511 and that corresponds to a channel (hereinafter, “display channel”) a video signal from which is currently being output is stored so that it can be referred to by the channel selection support module 52.

In response to viewer channel selection activity such as channel surfing or zapping, the channel selection support module 52 provides the viewer with information (hereinafter, “selection support information”) to support the viewer to revert back to the viewed channel. The channel selection support module 52 comprises a timer 521, a comparison/determination module 522, and the display control module 523.

The timer 521 is a clock such as a real time clock (RTC), and counts the time related to channel switching in cooperation with the comparison/determination module 522.

More specifically, the timer 521 has a first timer function for counting the view time with respect to each of channels selected by the channel selection control module 51. The term “view time” as used herein refers to the time during which a channel selected by the channel selection control module 51 is viewed. In addition, the timer 521 has a second timer function for counting the elapsed time until a new viewed channel is set through channel switching at least once from the present viewed channel. In the following, the view time counted by the first timer function is represented as “TMR 1”, while the elapsed time counted by the second timer function is represented as “TMR 2”.

The term “viewed channel” as used herein refers to a channel that the viewer frequently or mainly views. Incidentally, the two timer functions of the timer 521, i.e., the first timer function and the second timer function, may be implemented in any reasonable manner. For example, the two timer functions may be implemented by two independent clocks, or by a single clock that sums up the differences.

The comparison/determination module 522 determines whether TMR 1 counted by the timer 521 reaches a predetermined time (hereinafter, “view determination time”). According to the determination result, the comparison/determination module 522 determines whether the viewer is viewing a channel or selecting a channel. Upon determining that the viewer is viewing a channel, the comparison/determination module 522 sets the cannel as the viewed channel.

More specifically, when TMR 1 counted by the timer 521 reaches the view determination time, the comparison/determination module 522 determines that the viewer is viewing a channel (program), and sets the channel currently being displayed as the viewed channel. When TMR 1 counted by the timer 521 is less than the view determination time, the comparison/determination module 522 determines that the viewer is selecting a channel (program). The view determination time may be set to an arbitrary value such as one minute, five minutes, or the like.

Further, the comparison/determination module 522 compares a cannel set as the viewed channel with a channel currently being displayed. When both the channels match, the comparison/determination module 522 determines that the viewer is viewing the viewed channel. With this, even if the viewer switches the viewed channel to a plurality of channels and then reverts back to the viewed channel, the comparison/determination module 522 can determine the channel as the viewed channel. Incidentally, when the viewed channel is yet to be set such as when the TV receiver 100 is turned on, the comparison/determination module 522 determines that the viewer is selecting a channel.

The display control module 523 is a functional module that provides the viewer with the value of TMR 2 counted by the timer 521 while the viewer is selecting a channel other than the viewed channel, i.e., when the comparison/determination module 522 determines that the viewer is selecting a channel.

More specifically, the display control module 523 generates selection support information corresponding to the value of TMR 2 counted by the timer 521 while the comparison/determination module 522 determines that the viewer is selecting a channel. The term “selection support information” as used herein refers to information to support the viewer to revert back to a program originally viewed by the viewer, i.e., the viewed channel. Examples of the selection support information include information indicating the value of TMR 2 directly or in an estimatable form, a symbol or a message to encourage the viewer to revert back to the viewed channel. With reference to FIG. 2, a description will now be given of an example of how to provide the selection support information to the viewer.

FIG. 2 is a schematic diagram for explaining an example of how to indicate the selection support information according to the first embodiment. In FIG. 2, the horizontal axis is a time axis that represents the elapsed time TMR 2. FIG. 2 illustrates the state of the image display module 32 between respective time points (0, A, B, and C) of TMR 2 at a corresponding position above the time axis.

In FIG. 2, the time point 0 of TMR 2 indicates the time point immediately after the viewed channel (channel 6) is switched to another channel. In the first embodiment, when 0≦TMR 2<A, the display control module 523 does not generate selection support information, and therefore, selection support information is not displayed on the image display module 32.

When TMR 2 reaches or exceeds the time point A (for example, 60 seconds) without reverting back to the viewed channel, the display control module 523 generates selection support information G1 indicating the time point A and the viewed channel. The display control module 523 then displays the selection support information G1 on the image display module 32 in a predetermined display form (hereinafter, “first display form”). In the example of FIG. 2, as the selection support information G1 in the first display form, the display control module 523 displays the channel number “6” of the viewed channel in green color at the upper-left corner of the screen of the image display module 32.

Further, when TMR 2 reaches or exceeds the time point B (for example, 90 seconds) without reverting back to the viewed channel, the display control module 523 generates selection support information G2 indicating the viewed channel. The display control module 523 then displays the selection support information G2 on the image display module 32 in a second display form different from the first display form. In the example of FIG. 2, as the selection support information G2 in the second display form, the display control module 523 displays the channel number “6” of the viewed channel in red color at the upper-left corner of the screen of the image display module 32.

Still further, when TMR 2 reaches or exceeds the time point C (for example, 120 seconds) without reverting back to the viewed channel, the display control module 523 controls the image display module 32 to delete the display of the selection support information G2 from the screen. It is preferable that the value of the view determination time be equal to or larger than the value of the time point C.

As is exemplified in FIG. 2, if the selection support information is displayed in different colors according to the value of TMR 2, the viewer can estimate the value of TMR 2. Besides, the selection support information indicates the channel number of the viewed channel, which allows the viewer to visually check the channel number of the viewed channel.

Although FIG. 2 illustrates an example in which a channel number image is displayed as the selection support information, the selection support information is not limited to the example. For example, a symbol such as a circle, a character string, or a message (for example, “60 seconds has passed since program change”) may be displayed as the selection support information. In this case, if the image of such a symbol or the like is displayed in different colors or different messages are displayed according to the value of TMR 2, the viewer can estimate the value of TMR 2. Alternatively, the selection support information may be displayed in different sizes or displayed blinking so that the viewer can estimate the value of TMR 2. Further, an image indicating the value of TMR 2 may be displayed as the selection support information to directly indicate the value of TMR 2.

Besides, although FIG. 2 illustrates an example in which TMR 2 is divided at three time points A, B, and C and the selection support information is displayed correspondingly to each of the time points, the number of time points and the interval between respective time points are not limited to the example. For example, the selection support information is displayed in green color when 60 seconds have elapsed since the switching of the viewed channel. Next, the selection support information is displayed blinking in green color when 75 seconds have elapsed. Then, the selection support information is displayed in red color when 90 seconds have elapsed, and is displayed blinking in red color when 105 seconds have elapsed. After that, the selection support information is deleted when 120 seconds have elapsed. At the point that 180 seconds have elapsed, a channel currently being displayed is determined to be the viewed channel.

Referring back to FIG. 1, the remote controller 60 is used by the viewer, and, in response to input from the viewer, sends a command signal to the TV receiver 100 to operate the TV receiver 100. Examples of the command signal include a channel selection signal specifying a specific channel.

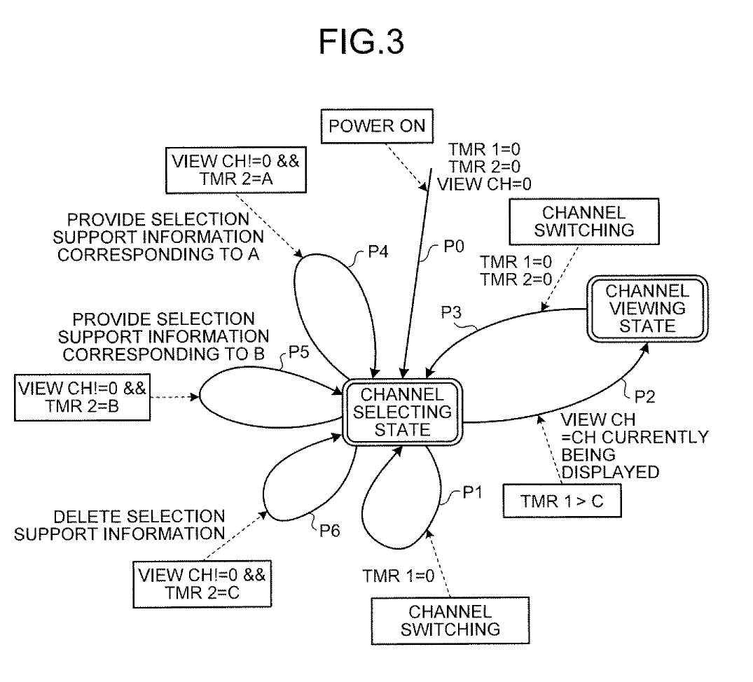

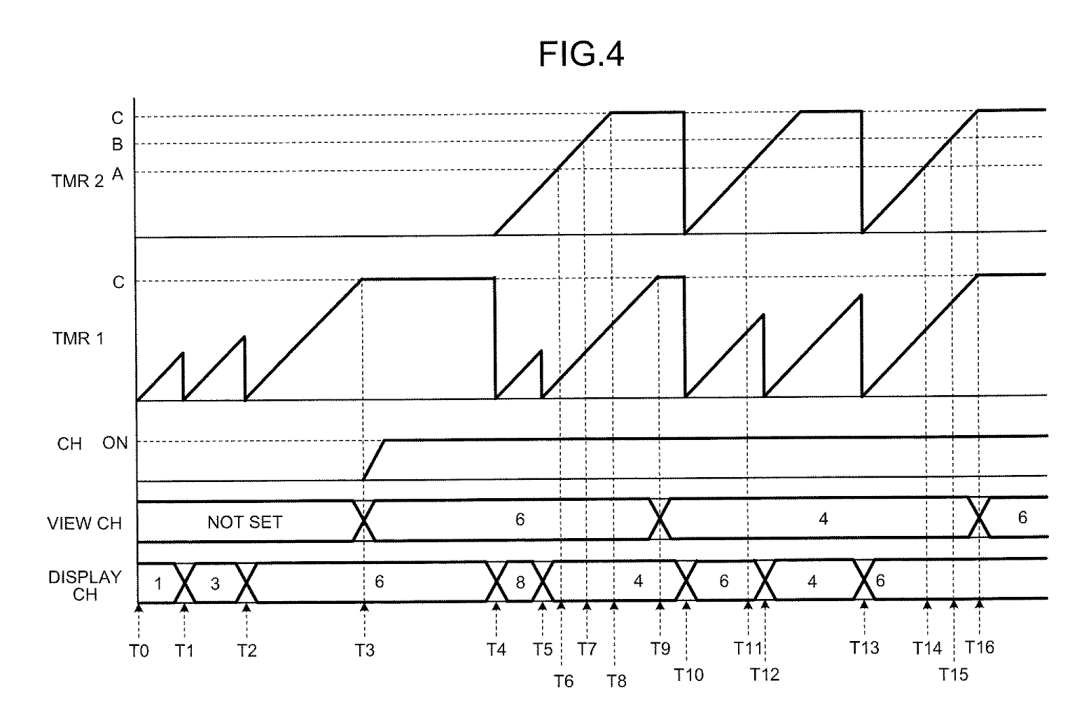

With reference to FIGS. 3 and 4, a description will be given of the operation of the channel selection support module 52. FIG. 3 is a state transition diagram for explaining two states determined by the channel selection support module 52 (the comparison/determination module 522) and the path of each process performed in each of the states. In FIG. 3, the two states (i.e., “channel selecting state” and “channel viewing state”) determined by the comparison/determination module 522 is each indicated in the double line box.

FIG. 4 is a timing chart for explaining the operation of the channel selection support module 52. In FIG. 4, “CH” indicates the state of setting of the viewed channel. More specifically, if “CH” is ON, it means that the viewed channel is set. Besides, “view CH” indicates the channel number of a channel determined to be the viewed channel by the comparison/determination module 522. Meanwhile, “display CH” indicates the channel number of a channel displayed on the image display module 32 at that time. Incidentally, in FIG. 4, the view determination time is represented by “C”.

When the TV receiver 100 is turned on (at time T0), channel 1 is selected as a default or the like. The timer 521 starts counting TMR 1 when channel 1 is selected under the control of the channel selection control module 51, i.e., when the TV receiver 100 is turned on at time T0. At this point, since the cannel number of the viewed channel (view CH) has not yet been set, the channel selection support module 52 determines that the viewer is selecting a channel (in the channel selecting state) as indicated by path P0 in FIG. 3.

Subsequently, when channel 1 is switched to channel 3 at time T1, the timer 521 resets the count of TMR 1. Further, when channel 3 is switched to channel 6 at time T2, the timer 521 again resets the count of TMR 1. In this manner, the timer 521 counts TMR 1 to determine the viewed channel, and resets the count thereof each time a channel is switched to another as indicated by path P1 in FIG. 3.

If TMR 1 reaches the view determination time C with respect to channel 6 at time T3, the comparison/determination module 522 determines that the viewer is viewing the channel, i.e., the channel selecting state shifts to the channel viewing state, and sets channel 6 as the viewed channel as indicated by path P2 in FIG. 3.

Thereafter, when channel 6 is switched to channel 8 at time T4, the timer 521 resets the count of TMR 1, and starts counting TMR 2. At this point, the comparison/determination module 522 determines that the viewer is selecting a channel, i.e., the channel viewing state shifts again to the channel selecting state as indicated by path P3 in FIG. 3.

When channel 8 is switched to channel 4 at time T5, the timer 521 resets only the count of TMR 1, and continues to count TMR 2 as indicated by path P1 in FIG. 3.

If TMR 2 reaches the time point A while channel 4 is selected (at time T6), the display control module 523 generates selection support information corresponding to TMR 2=A. The display control module 523 then displays an image on which is overlaid the selection support information on the image display module 32 to provide the viewer with the selection support information as indicated by path P4 in FIG. 3. Further, if TMR 2 reaches the time point B (B>A) while channel 4 is selected (at time TV), the display control module 523 generates selection support information corresponding to TMR 2=B. The display control module 523 then displays an image on which is overlaid the selection support information on the image display module 32 to provide the viewer with the selection support information as indicated by path P5 in FIG. 3. Still further, if TMR 2 reaches the time point C (C>B) while channel 4 is selected (at time T8), the display control module 523 controls the image processor 31 to delete the display of the selection support information from image display module 32 as indicated by path P6 in FIG. 3.

After that, if TMR 1 reaches the view determination time C while channel 4 is selected (at time T9), the comparison/determination module 522 determines that the viewer is viewing the channel, i.e., the channel selecting state shifts to the channel viewing state, and sets channel 4 as the viewed channel as indicated by path P2 in FIG. 3.

Subsequently, when channel 4 is switched to channel 6 at time T10, the timer 521 resets the counts of TMR 1 and TMR 2. Besides, the comparison/determination module 522 determines that the viewer is selecting a channel, i.e., the channel viewing state shifts again to the channel selecting state as indicated by path P3 in FIG. 3.

If TMR 2 reaches the time point A while channel 6 is selected (at time T11), the display control module 523 generates selection support information corresponding to TMR 2=A. The display control module 523 then displays an image on which is overlaid the selection support information on the image display module 32 as indicated by path P4 in FIG. 3.

At this point, if the viewer instructs to switch the channel to the viewed channel (channel 4) based on the selection support information displayed on the image display module 32, the channel selection control module 51 controls the tuner 12 to switch the channel to channel 4 (at time T12). When channel 6 is switched to channel 4, the timer 521 resets the count of TMR 1. Since the channel number “4” of the viewed channel set at time T9 matches the channel number “4” of the channel currently being displayed, the comparison/determination module 522 determines that the viewer is viewing the channel, i.e., the channel selecting state shifts again to the channel viewing state as indicated by path P2 in FIG. 3.

Thereafter, when channel 4 is switched to channel 6 at time T13, the timer 521 again resets the counts of TMR 1 and TMR 2. Besides, the comparison/determination module 522 determines that the viewer is selecting a channel, i.e., the channel viewing state shifts again to the channel selecting state as indicated by path 23 in FIG. 3.

If TMR 2 reaches the time point A while channel 6 is selected (at time T14), the display control module 523 generates selection support information corresponding to TMR 2=A. The display control module 523 then displays an image on which is overlaid the selection support information on the image display module 32 as indicated by path P4 in FIG. 3. Further, if TMR 2 reaches the time point B while channel 6 is selected (at time T15) the display control module 523 generates selection support information corresponding to TMR 2=B. The display control module 523 then controls the image processor 31 to display an image on which is overlaid the selection support information on the image display module 32 as indicated by path P5 in FIG. 3.

Still further, if TMR 2 reaches the time point C while channel 6 is selected (at time T16), the display control module 523 stops generating selection support information, and thereby deletes the display of selection support information from the image display module 32 as indicated by path P6 in FIG. 3. In addition, since TMR 1 reaches the view determination time C at this time, the comparison/determination module 522 determines that the viewer is viewing the channel, i.e., the channel selecting state shifts to the channel viewing state, and sets channel 6 as the viewed channel as indicated by path P2 in FIG. 3.

As described above, according to the first embodiment, when the view time (TMR 1) of a channel reaches or exceeds the view determination time, the channel is set to the viewed channel. Then, the elapsed time (TMR 2) is counted from when the viewed channel is switched to another channel. Accordingly, even if the viewed channel is switched to a plurality of channels, the time elapsed since switching from the viewed channel can be provided to the viewer directly or in an estimatable form. This encourages the viewer to revert back to the viewed channel. Therefore, it is possible to prevent such a situation that the viewer misses a program (the viewed channel) that he/she has originally viewed while distracted by a program after channel switching. Thus, convenience for the viewer can be increased.

Moreover, an image indicating the channel number of the viewed channel is used as selection support information. As a result, the viewer can recognize the channel number of the viewed channel and the time (TMR 2) elapsed since switching from the viewed channel more intuitively.

In the first embodiment, the image display module 32 displays selection support information indicating the time elapsed since switching from the viewed channel to encourage the viewer to revert back to the viewed channel. The elapsed time need not necessarily be provided in this manner. According to a second embodiment of the invention, the elapsed time is provided by using a device that indicates the elapsed time. Incidentally, constituent elements corresponding to those of the first embodiment are designated by the same reference numerals, and their description will not be repeated.

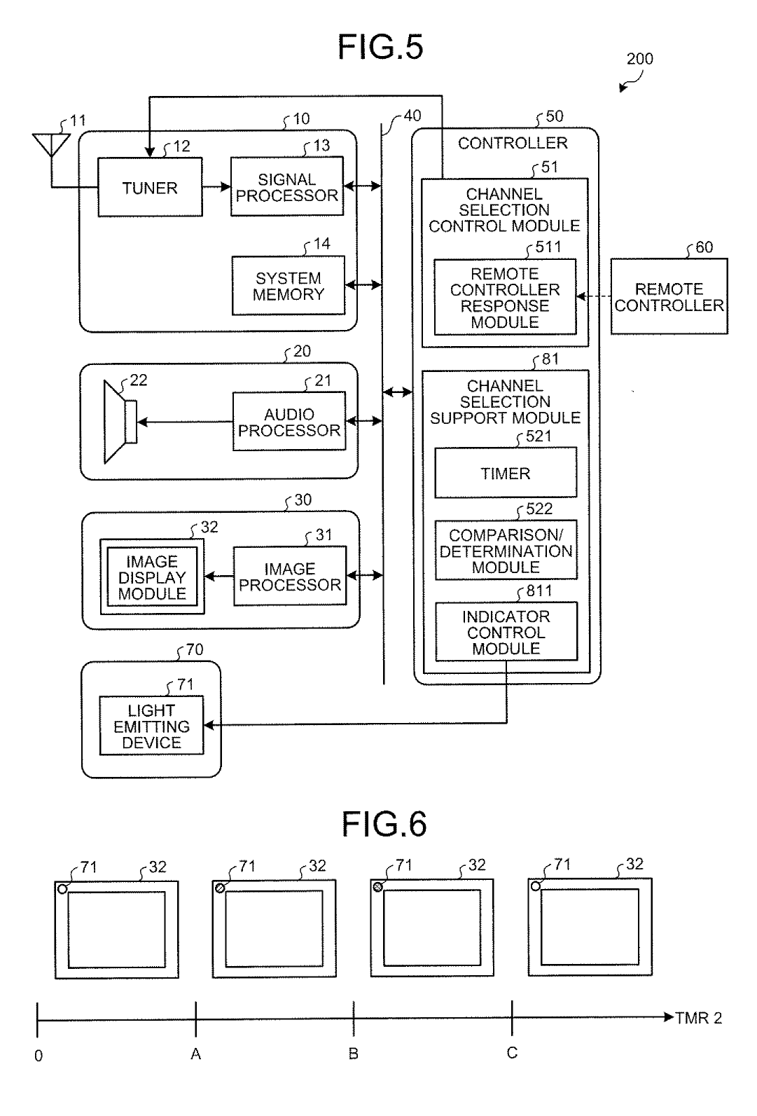

FIG. 5 is a schematic block diagram of a TV receiver 200 according to the second embodiment. As illustrated in FIG. 2, the TV receiver 200 comprises the TV signal receiving module 10, the audio output module 20, the video output module 30, the bus 40, the remote controller 60, an indicator 70, and a controller 80. The TV signal receiving module 10, the audio output module 20, and the video output module 30 are connected via the bus 40 to the controller 80, and operate under the control of the controller 80.

The indicator 70 comprises a light emitting device 71, such as a light emitting diode (LED), that emits light in one or more colors. The indicator 70 emits light under the control of an indicator control module 811, which will be described later. The light emitting device 71 may be located on the frame of the image display module 32 so that the viewer can view the light emitted from the light emitting device 71 together with the screen of the image display module 32.

The controller 80 controls the overall operation of the TV receiver 200. The controller 50 comprises the channel selection control module 51 and a channel selection support module 81 as functional modules related to channel switching.

The channel selection support module S1 comprises the timer 521, the comparison/determination module 522, and the indicator control module 811. The indicator control module 811 is a functional module that controls the indicator 70 to provide the viewer with the value of TMR 2 counted by the timer 521 by the light emitted from the light emitting device 71 while a channel other than the viewed channel is selected, i.e., when the comparison/determination module 522 determines that the viewer is selecting a channel.

More specifically, the indicator control module 811 controls light emission from the indicator 70 according to the value of TMR 2 counted by the timer 521 while the comparison/determination module S22 determines that the viewer is selecting a channel. With this, the light emitting device 71 emits light in a predetermined color and/or a predetermined pattern. Thus, the value of TMR 2 is provided to the viewer directly or in an estimatable form. With reference to FIG. 6, a description will be given of an example of how to provide the value of TMR 2 to the viewer.

FIG. 6 is a schematic diagram for explaining an example of how to indicate the value of TMR 2. In FIG. 6, the horizontal axis is a time axis that represents the elapsed time TMR 2. FIG. 2 illustrates the state of the light emitting device 71 between respective time points (0, A, B, and C) of TMR 2 at a corresponding position above the time axis.

In FIG. 6, the time point 0 of TMR 2 indicates the time point immediately after the viewed channel (channel 6) is switched to another channel. In the second embodiment, when 0≦TMR 2<A, the light emitting device 71 does not emit light.

When TMR 2 reaches or exceeds the time point A (for example, 60 seconds) without reverting back to the viewed channel, the indicator control module 811 controls the light emitting device 71 to emit light in a predetermined color and/or a predetermined pattern (hereinafter, “first light emitting form”).

In the example of FIG. 6, as the first light emitting form, the indicator control module 811 controls the indicator 70 to emit green light with the light emitting device 71.

Further, when TMR 2 reaches or exceeds the time point B (for example, 90 seconds) without reverting back to the viewed channel, the indicator control module 811 controls the light emitting device 71 to emit light in a second light emitting form different from the first light emitting form. In the example of FIG. 6, as the second light emitting form, the indicator control module 811 controls the indicator 70 to emit red light with the light emitting device 71.

Still further, when TMR 2 reaches or exceeds the time point C (for example, 120 seconds) without reverting back to the viewed channel, the indicator control module 811 controls the light emitting device 71 not to emit light. It is preferable that the value of the view determination time be equal to or larger than the value of the time point C.

As is exemplified in FIG. 6, if the light emitting device 71 emits light in different colors according to the value of TMR 2, the viewer can estimate the value of TMR 2. Although FIG. 6 illustrates an example in which the light emitted from the light emitting device 71 changes from green to red according to the value of TMR 2, the color of the light is not so limited, and light in any color may be used. Besides, as the light emitting pattern of the light emitting device 71, the light emitting device 71 may blink to indicate the value of TMR 2 in an estimatable form. Further, if the light emitting device 71 is configured to be capable of count display, the value of TMR 2 may be displayed directly.

Incidentally, the channel selection support module 81 operates in a similar manner to the channel selection support module 52 of the first embodiment except for the part related to the generation and provision of selection support information. Therefore, its description will not be repeated.

As described above, according to the second embodiment, when the view time (TMR 1) of a channel reaches or exceeds the view determination time, the channel is set to the viewed channel. Then, the elapsed time (TMR 2) is counted from when the viewed channel is switched to another channel. Accordingly, even if the viewed channel is switched to a plurality of channels, the time elapsed since switching from the viewed channel can be provided to the viewer directly or in an estimatable form. This encourages the viewer to revert back to the viewed channel. Therefore, it is possible to prevent such a situation that the viewer misses a program (the viewed channel) that he/she has originally viewed while distracted by a program after channel switching. Thus, convenience for the viewer can be increased.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A television receiver comprising:
a receiver configured to selectively receive a plurality of broadcasts in response to switching of channels;
a setting module configured to set a channel as a viewed channel when a predetermined time has elapsed since switching to the channel;
a timer configured to count an elapsed time until a new viewed channel is set through at least one channel switching from the viewed channel; and
an indicator configured to indicate the elapsed time while a channel other than the viewed channel is selected.

2. The television receiver of claim 1, wherein the indicator is configured to indicate the elapsed time in different manners depending on the elapsed time.

3. The television receiver of claim 1, further comprising a display module configured to display an image of each of the broadcasts, wherein
the indicator is configured to control the display module to display selection support information indicating the elapsed time overlaid on the image.

4. The television receiver of claim 3, wherein the indicator is configured to change at least one of color and form of the selection support information depending on the elapsed time.

5. The television receiver of claim 1, further comprising a light emitting module configured to emit light in a plurality of colors, wherein
the indicator is configured to control the light emitting module to change at least one of light color and light emitting manner depending on the elapsed time to indicate the elapsed time.

6. A television receiving method comprising:
selectively receiving a plurality of broadcasts in response to switching of channels;
setting a channel as a viewed channel when a predetermined time has elapsed since switching to the channel;
counting an elapsed time until a new viewed channel is set through at least one channel switching from the viewed channel; and
indicating the elapsed time while a channel other than the viewed channel is selected.

7. The television receiving method of claim 6, wherein
the receiving is performed by a receiver,
the setting is performed by a setting module,
the counting is performed by a timer; and
the indicating is performed by an indicator.
